(19) United States
(12) Patent Application Publication
(10) Pub. No.: US 2008/0109337 A1
(43) Pub. Date: May 8, 2008

(54) Method of financing and maintaining a railway track

(75) Inventors: Tayton Dencer, Los Angeles, CA (US); Jelle Mensonides, New York, NY (US)

Correspondence Address: FULWIDER PATTON LLP, 200 OCEANGATE, SUITE 1550, LONG BEACH, CA, 90802, US

(73) Assignee: Polymer Global Holdings

(21) Appl. No.: 11/593,848

(22) Filed: Nov. 7, 2006

(51) Int. Cl. G06Q 40/00

(52) U.S. Cl. 705/35

(57) ABSTRACT

The present invention proposes a leasing arrangement of composite railroad ties constructed of, for example, recycled automobile tires, to a customer over a lengthy term while ownership in the ties remains with the supplier/leassor. The leasing arrangement can be spread over twenty years or longer, such that the initial start up costs is a fraction of that for wood ties, much less composite ties, and the customer also realizes the benefits of the enhanced durability of the composite ties. The supplier may also agree to replace the composite ties as necessary, and thus the customer has a fixed and manageable annual (or other incremental) cost that provides predictability and low cost insurance that is not available for purchased ties.

### BACKGROUND OF THE INVENTION

The present invention relates generally to the financing of railway systems, and more particularly to a financial arrangement between the purveyor of composite railway ties and the proprietor of a railway track that permits the railway owner to acquire more durable, longer lasting synthetic railway ties in a novel financial arrangement that avoids the inherent high start-up costs associated with said ties.

Financing a railway has always been a very expensive endeavor, as evidenced by the Federal programs such as the railroad rehabilitation and improvement financing program sponsored by the Federal Government. The program makes funding available through loans and loan guarantees for railroad capital improvements. This program disburses loans that are to be used to acquire, improve, develop or rehabilitate rail equipment and facilities, including track, bridges, yards and shops. The U.S. railroad industry and its workers have benefited from the rise in foreign import trade. Intermodal traffic has tripled since 1980, powered by international container business. The industry has hired tens of thousands of new employees in recent years, many in train service, evidencing a growth in the railway industry. Freight railroads are expected to hire more than 80,000 new workers over the next six years, one industry group has recently reported. In the last 25 years, railroads have invested $120 billion in capital projects.

With the growth in the railway industry continuing, methods for financing new railways and expanding and refurbishing existing railroads is at the forefront of many interested parties. One longstanding difficulty is the cost of the ties that support the rails and form the base for the track.

The basic construction of railroad tracks are centuries old, and include steel bars called “rails” that are arranged in a parallel manner to guide and support the train. The rails are coupled together end to end using a bolted coupling leaving a small gap between the ends of the rails to allow for thermal expansion and contraction. Each rail is supported on a plurality of tie plates that are held in place by spikes through a plank otherwise referred to as a crosstie, or simply a tie. Railroad ties serve the function of not only supporting the rails but also maintaining the proper distance between rails under expected loads. Failure to adequately serve either of these roles can lead to a derailment, endangering both lives and property. Yet, railroad ties are subject to extremely harsh conditions, thereby increasing the chance of derailment. A discussion of the environments encountered by railroad ties and the effects thereon is discussed in U.S. Pat. No. 6,191,228 to Nosker, issued Feb. 20, 2001 and assigned to Polywood Inc. of Edison, N.J., the contents of which are incorporated herein by reference.

Dating back to the origins of the train as a means of transportation, the ties have been made of wood. The wooden ties are planks arranged traverse to the rails and parallel to each other, typically about 8 inches wide and 6 inches thick, and support the rails and the train when it passes over. On average, each mile of track requires as many as twenty five hundred ties or more. Wood was historically used for the railway ties mainly because of its availability and its capacity for absorbing the impact of fast-moving and heavy trains without breaking or chipping. However, wood has certain disadvantages due to its propensity for deterioration caused by environmental factors like humidity, water, and fungi. Ties are also exposed to large temperature variations, excessive amounts of ultraviolet light, severe weather conditions, attack from microorganisms and insects, and stress imposed by use. As a result, wooden ties be replaced every 5 to 7 years on average.

In general, a railroad tie must be able to maintain the desired distance between and under a lateral load of 24,000 lbs., a static vertical load of 39,000 lbs., and a dynamic vertical load of 140,000 lbs. Thus, for a typical railway wherein the distance (gauge) between the rails is 56.5 inches, the ties must be able to maintain this distance without increasing by more than 0.125 inches, under the expected temperature and load variations, so as to prevent derailment. To effectively withstand such loads, the tie material must possess both stiffness and strength. In this regard, a railroad tie should, in general, exhibit the following physical properties:

compression modulus: at least about 172,000 psi

flexural modulus: at least about 172,000 psi

compression yield stress: at least about 3,000 psi

compression strength: at least about 3,000 psi

flexural strength: at least about 3,000 psi

Another factor regarding maintaining the proper distance between rails is thermal expansion. To be suitable as a railroad tie, the material must exhibit a low thermal expansion. Preferably, the material has a coefficient of thermal expansion of less than 6×10 exp.−5 in/in/degree F. To prevent the occurrence of accidents, the materials used for manufacturing railroad ties need to be stiff, strong and resistant to ultraviolet light, temperature fluctuations, and microbe/insect attack. Also, the material should be nonconductive to preclude electrical flow between the rails. For example, for freight railways, electrical signals are sent through the rails for purposes of communication between the front and back of the train. For passenger railways, electrical power is often sent through the rails themselves. Therefore, to prevent electrical shorts between the rails, the ties supporting the rails should be made from nonconductive materials.

The tie material should also be durable to avoid deterioration due to abrasion during use. For example, one form of abrasion associated with railroad ties is tie seat abrasion. This occurs when the tie plates cut into the ties. Ties that are made from materials that are stiffer and stronger than wood in the direction perpendicular to the tie axis are better at alleviating tie seat abrasion. Since the rails are to be attached to the ties, the tie material also has to be suitable for use with typical types of fasteners, such as those used for wood materials, e.g., nails, screws, spikes, bolts, etc.

Typically, railroad ties are manufactured from wood, and to some extent steel-reinforced concrete. While wood is a relatively inexpensive material, it is very susceptible to attack from microorganisms such as fungi and insects, which will weaken and deteriorate the tie. To compensate for this, wooden railroad ties can be chemically treated to resist such attacks. Examples of such chemical treatments are creosote treatment and chromate/copper/arsenic treatment. These treatments greatly increase costs. Further, chemical treatments only delay the attack, not prevent it. Wooden ties are also quite susceptible to damage from harsh weather conditions and excessive sunlight. As a result of these drawbacks, wooden ties require frequent replacement or re-gauging, again increasing costs, in materials, labor, and disposal. Replacement and/or re-gauging costs can be quite substantial as ties are being utilized in numbers of about 2500-3000 ties per mile.

Aside from the safety issues, a business related problem with wooden ties is the unpredictability in the failure of the ties, as wood reacts differently to different weather conditions. Unexpected costs can arise in the operation of a railway if the weather season is uncharacteristically rainy or damp, or even excessively dry. Localized infestations of fungi, parasites, and insects can also unexpectedly damage large numbers of wooden ties resulting in a high cost to the railway operator. The use of wooden ties thus presents a potential for unforeseen cost spikes that makes operation of a railway unpredictable in terms of cash flow and maintenance costs.

Similarly, steel-reinforced concrete railroad ties are also susceptible to degrading forces, for example, abrasion, stress and strain. In fact, concrete ties have been found to cause premature failure of rails. This is because concrete ties are generally very stiff. As a result, when placed at the standard distance, the ties do not aid in absorbing the stress imposed on the rails thereby forcing the rails to flex more between the ties under load. To address this problem, concrete ties are often spaced closer together than wooden ties. This, of course, leads to increased costs.

Damp and freezing weather conditions cause damage to both wooden and concrete railroad ties alike. Water from rain or snow can penetrate into the surface of a wooden or concrete railroad tie. If the tie is then exposed to freezing conditions, the water will expand as it freezes, causing the formation of cracks thereby weakening the tie. In the case of reinforced concrete ties, such cracks can also lead to oxidation of the reinforcement bars.

The difficulties with wooden ties and concrete ties have led to other materials being considered that do not degrade as quickly and whose life expectancy in this application is more predictable. Plastic polymers and plastic composite materials offer a viable alternative to wood and concrete. Composite ties can exhibit the necessary stiffness strength, resistance to heat expansion and deformation, as well as increased resistance to degradation from moisture, excessive sunlight and attacks by microorganisms and insects. These plastic ties would also have a longer expected service life thereby reducing the labor and material costs associated with replacement. Due to the inherent resistance to microorganisms, insects, and moisture, plastic ties obviate the need for chemical treatments used for wooden ties. This represents not only a cost savings, but will also eliminate waste disposal problems for chemically treated wooden ties.

However, the cost of raw materials is a disadvantage of plastic polymers and plastic composites. Virgin polymer resins can be quite expensive thereby making their use economically unfeasible. Accordingly, alternative materials have been explored that have the benefits of plastic ties without the prohibitive costs associated with virgin plastics. A recent patent, Nosker et al. (U.S. Pat. No. 5,789,477), incorporated herein by reference, describes the requirements of materials used for railroad ties as well as the disadvantages and pitfalls of the known wooden and steel-reinforced concrete railroad ties. As a substitute material, Nosker et al. disclose a composite made from coated fibers, such as fiber glass or carbon fibers, distributed within a polymer component containing about 80-100% high density polyethylene (HDPE). The polymer component can be made from recycled plastics. Again, however, the costs of the raw materials when compared with wood make the commercial application of such exotic plastics unfeasible for present day use.

One candidate that has recently been proposed is a composite material made of recycled automobile tires that has shown remarkable wear characteristics as compared with wooden ties. These composite ties can last over twenty years, and the shock absorption characteristics of the composite ties are comparable or even preferable to their wooden counterparts. The cost of the composite ties are approximately fifty percent higher than the wooden ties, but any consideration of the higher cost of the composite ties must also include a discussion of the extended life expectancy and resistance to deterioration.

U.S. Pat. No. 5,238,734 to Kevin Murray, issued Aug. 24, 1993, the contents of which are fully incorporated by reference herein, describes a railroad tie made of rubber fragments from discarded tires. Murray notes that roughly 3 billion discarded tires from automobiles and trucks litter the American landscape, and 200 million more are discarded every year. Although some discarded tires are dumped offshore to create fishing reefs, that method of disposal is impractical for tires located long distances from coastlines. Most discarded tires sit in open dumps, where they collect rainwater and serve as breeding grounds for mosquitoes, rats, and other pests. More information on various problems relating to the disposal or recycling of discarded tires is contained in the introductory section of U.S. Pat. No. 4,726,530 (Miller and Priscu 1988). As such, discarded tires provides a supply for the materials used to create the composite ties that rivals wood in its availability and costs of the raw materials.

Murray concluded that railroad ties made of recycled rubber are sufficiently strong and durable to render them economically feasible and even preferable in environments where wooden ties have short lifespans. This is especially true in regions with frequent snow or rain that are subject to frequent cycling above and below the freezing point of water; the frequency of cycling above and below freezing is more important than average temperatures, since each time the temperature drops below freezing, any rainfall or melted snow which has coated or seeped into the tie will freeze, and the expansion of the ice as it freezes forces apart the fibers in the wood, causing it to crack and split. In some environments, wooden ties show substantial signs of wear within two or three years, and must be replaced often to ensure adequate margins of safety for the trains passing over them. Replacement is a very expensive process; the cost of labor, new spikes, new tie pads, lost travel time on the rails, and other related expenses for removing cracked ties and installing new ties beneath a railroad usually amount to substantially more than the cost of the ties.

Despite the foregoing, the initial costs of composite railway ties have kept the ties from catching on in the commercial sect. The cost of building a railway system with composite ties or initiating a widespread replacement of wooden ties with composite ties on an existing railway system comes with a significantly higher up front cost, which has been found to be a significant deterrent in the introduction of the new ties. Because the additional start-up costs can be in the hundreds of thousands of dollars or even millions, wood remains the tie material of choice despite the favorable return on the composite ties when compared with wood. To date, certain purveyors of composite ties have been forced to either drop the price of the composite ties to a value comparable with wood, resulting in an operating loss, or to forego the sales of the ties to would-be customers. A viable solution for the purveyors of the composite ties at present does not exist that satisfies both the provider's need for profit and the railway owner's need to avoid the increased start-up costs associated with a transition from wooden ties to composite ties.

### SUMMARY OF THE INVENTION

The present invention overcomes the shortcomings that presently exist in the financing and maintenance of railway systems by using a unique and novel finacing method to provide customers with composite railway ties without the inherent start-up costs associated with the same. That is, the present invention proposes a leasing arrangement of the composite ties to the customer over a lengthy term while ownership in the ties remains with the supplier. The leasing arrangement can be spread over twenty years or longer, such that the initial start up costs is a fraction of that for wood ties, much less composite ties, and the customer also realizes the benefits of the enhanced durability of the composite ties. The supplier may also agree to replace the composite ties as necessary, and thus the customer has a fixed and manageable annual (or other incremental) cost that provides predictability and low cost insurance that is not available for wooden ties. Accordingly, the present invention balances the benefits of the new arrangement by apportioning a majority of the initial investment as well as the ownership of the composite ties with the supplier, who in turn realizes greater profits and a predictable return. Meanwhile, the customer benefits from significantly lower start up costs that frees up cash flow to other business needs, and provides predictability with the costs and overhead and expenses of financing and maintaining a railway system.

Other features and advantages of the invention will become apparent from the following detailed description, taken in conjunction with the accompanying drawings which illustrate, by way of example, the features of the invention

### BRIEF DESCRIPTION OF THE DRAWINGS

FIG. 1 is a step diagram illustrating the proposed method of the present invention.

### DETAILED DESCRIPTION OF THE PREFERRED EMBODIMENTS

A lease is a contract through which an owner of equipment, the leassor, conveys the right to use its equipment to another party, the lessee, for a specified period of time and for specified periodic payments. A lease schedule is a schedule to a master lease agreement describing the leased equipment, rentals and other terms applicable to that equipment. A lease term is the fixed, non-cancelable duration of the lease. A lessee is the party to a lease agreement who has been given the right to use the equipment for the lease term by the party who has legal or tax title to the equipment and who is entitled to receive rental payments from the lessee. The leassor is the owner of equipment that is being leased to a lessee or user.

There are many benefits to a lessee/business for leasing certain equipment rather than purchasing. Some of these are the following:

Conserve Capital: By leasing equipment, the lessee can make better use of its working capital to meet the day-to-day needs of its business, like business development, paying suppliers or payroll.

Protect Credit Lines: By leasing, there is no impact on existing lines of credit with your bank.

Hedge Against Inflation: By leasing, the lessee can acquire use of equipment at today's costs while meeting rental payments with tomorrow's inflated dollars. As price levels continue upward leasing offers a very clear advantage.

Pay for Use: By leasing, the lessee has a monthly payment that matches the useful life of the equipment instead of paying a large purchase price up front. Business and industry profit by using equipment, not owning equipment.

Budget Restrictions: By leasing, the lessee has minimum cash outlay up front, plus modest payments that enable it to fit the lease payment into its budget. Leasing makes it possible to obtain the necessary equipment when it is needed.

Simplified Transaction: By leasing, the lessee may qualify for favorable tax deductions that further reduce the cost of the lease.

Protection Against Obsolescence: By leasing, the lessee has the opportunity to replace equipment after the lease, which in turn can increase production. This gives the lessee the flexibility to return the equipment, buy it and use it or dispose of it for a profit, or renew payments at the end of the lease term. Worn out or insufficient equipment are easily replaced.

Providing lease financing helps the equipment suppliers increase sales by offering lease financing to their clients as part of other services. With good credit and positive cash flow, lease underwriters will give lessees more credit than others because the transactions are asset backed.

Leasing typically involves a small monthly payment. When you know what bills are coming it reduces impact on cash flow and makes cash flow forecasting easier. Customers will often decide to acquire more costly equipment and/or more equipment than if they had to purchase with cash. The results in increased income to suppliers because additional orders and equipment upgrades often lead to more sales. A lease payment can be often approved from customers' operating budget, as there is often no need for head office approval. In addition, available budget dollars will allow the leasing of more equipment over a given period of time which can lead to multiple sales. At the end term, lessees will often go back to the original dealer to upgrade or purchase new equipment and the lessee most likely has already become accustomed to making lease payment.

An Operating Lease is treated as a true lease (not a loan) for book accounting purposes. This can be important as explained below. As defined in Financial Accounting Standards Board Statement No. 13, an operating lease must have all of the following characteristics: (1) Lease term is less than 75% of the estimated economic life of the equipment; (2) Present value of lease payments is less than 90% of the equipment's fair market value; (3) Lease cannot contain a bargain purchase option (i.e., less than fair market value); and (4) Ownership is retained by the leassor during and after the lease term. An operating lease is accounted for by the lessee without showing an asset (for the equipment) or a liability (for the lease payment obligations) on the lessee's balance sheet. A lease that qualifies as an operating lease for the lessee's financial accounting purposes is often referred to as Off-Balance Sheet Financing due to their exclusion from the balance sheet asset and debt presentation except for that portion of the payments that is due in the current fiscal period. Full disclosure of such transactions is typically made in the auditor's notes to the financial statements. Periodic statements are recorded as expense items on the lessee's income statement.

Companies frequently enter into long-term lease agreements in which customers pay a single negotiated monthly fee in return for the equipment, service, supplies and financing, referred to as bundled leases. Under generally accepted accounting principles (GAAP), most of the fair market value of a leased product can be recognized as revenue immediately if certain requirements are met, while non-equipment revenues such as service and financing are recognized over the term of the lease.

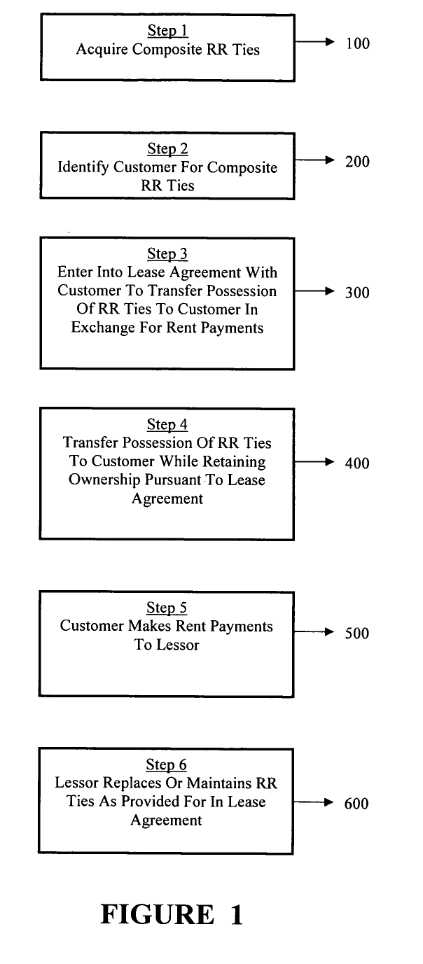

Given the advantages of leasing equipment from the prospective of the customer, the advantages of the present invention will become clear. FIG. 1 is a step diagram of the method of financing the railway of the present invention. The first step is the acquisition of composite railway ties (step 100), which can be through manufacture or purchase. Composite railway ties can be of the type disclosed in U.S. Pat. No. 5,238,734 to Kevin Murray, issued Aug. 24, 1993, or a similar railway tie made from recycled tires. It should be understood that any composite material suitable for the incorporation into railway crossties may suffice for purposes of the present invention. Acquisition can be through manufacture, purchase, or any other mode of acquisition of the composite ties. The second step is to identify a customer for the composite ties (step 200), which can be achieved through a variety of means. Existing railway operators are prime candidates for the composite ties, and new permits for operating a railroad are a matter of public record that can identified for sources of potential customers.

The next step is to enter into an agreement between the provider of the composite ties and the customer for the composite ties (step 300), and the identify a length of the term for the financial arrangement where the ties would be leased to the customer while ownership in the ties would remain with the provider of the ties. The term can be for twenty years, forty years, or any mutually acceptable term for the lease of the ties. Other terms of the lease are then mutually agreed upon, such as provisions for early termination, method and timing of payments by the customer, provisions for non-payment, options to buy the ties, conditions for replacing the composite ties, laws to govern the lease agreement, force majeure clauses, penalties for non-performance or late payments, enforcement of the agreement, and other customary clauses found in lease agreements. Once the agreement has been completed and executed, possession of the composite ties is transferred to the customer while title is retained by the tie provider (step 400). The final step is the payment of regularly scheduled rent payments from the lessee to the leassor under the conditions of the lease agreement (step 500). Also, as ties wear and require replacement, substitute composite ties may be provided to the customer as part of the lease agreement (step 600) such that the customer only incurs a regularly scheduled rent payment for use and replenishment of the composite ties, where the scheduled rent payment is far less than the purchase price of a set of ties of either wood or composite. Under the terms of the lease, the customer pays the rent for the duration of the term and, once the term of the lease agreement has expired the ties are collected, disposed of, or otherwise handled in a mutually agreed manner between the customer and the tie provider.

An example is helpful in illustrating the benefits of the present invention. A few basic assumptions will aid in the understanding of the invention, although such assumptions are merely exemplary and do not form any part of the invention per se.

The example begins with a premise that mean value of a life cycle of a wooden railroad tie is 8.9 years and a total cycle (replacement of all wooden ties) is fifteen years. Similarly, the mean value of a life cycle of a composite railroad tie is 20.6 years and a total cycle is thirty-one years. These numbers are based on some studies on the subject, but other data would likely result in changes to these assumptions. The probability of failure for the two types of ties are illustrated here:

| | Wood | Wood |
|---|---|---|
| | Percentage | Total |
| | of Failed | Failed |
| year | Ties | Ties |
| 1 | 0.0% | 0.0% |
| 2 | 0.5% | 0.5% |
| 3 | 0.5% | 1.0% |
| 4 | 1.0% | 2.0% |
| 5 | 5.0% | 7.0% |
| 6 | 5.0% | 12.0% |
| 7 | 10.0% | 22.0% |
| 8 | 20.0% | 42.0% |
| 9 | 25.0% | 67.0% |
| 10 | 17.0% | 84.0% |
| 11 | 5.0% | 89.0% |
| 12 | 4.0% | 93.0% |
| 13 | 3.0% | 96.0% |
| 14 | 2.0% | 98.0% |
| 15 | 2.0% | 100.0% |
| 16 | | 100.0% |
| 17 | | 100.5% |
| 18 | | 101.0% |
| 19 | | 102.0% |
| 20 | | 107.0% |
| 21 | | 112.0% |
| 22 | | 122.0% |
| 23 | | 142.0% |
| 24 | | 167.0% |
| 25 | | 184.0% |
| 26 | | 189.0% |
| 27 | | 193.0% |
| 28 | | 196.0% |
| 29 | | 198.0% |
| 30 | | 200.0% |
| 31 | | 200.0% |
| 32 | | 200.5% |
| 33 | | 201.0% |
| 34 | | 202.0% |
| 35 | | 207.0% |
| 36 | | 212.0% |
| 37 | | 222.0% |
| 38 | | 242.0% |
| 39 | | 267.0% |
| 40 | | 284.0% |

The table shows that after eight years, forty-two percent of the wooden ties will need to be replaced under the current assumptions. Moreover, after thirty years all wooden ties will need to be replaced twice, and after forty years almost all of the wooden ties will require replacement a third time. Conversely, the composite ties replacement probabilities are as follows:

| | Composite | Composite |
|---|---|---|
| | Percentage | Total |
| | of Failed | Failed |
| year | Ties | Ties |
| 1 | 0.0% | 0.0% |
| 2 | 0.0% | 0.0% |
| 3 | 0.5% | 0.5% |
| 4 | 0.5% | 1.0% |
| 5 | 0.5% | 1.5% |
| 6 | 0.5% | 2.0% |
| 7 | 1.0% | 3.0% |
| 8 | 1.0% | 4.0% |
| 9 | 1.0% | 5.0% |
| 10 | 1.0% | 6.0% |
| 11 | 1.0% | 7.0% |
| 12 | 2.0% | 9.0% |
| 13 | 2.0% | 11.0% |
| 14 | 3.0% | 14.0% |
| 15 | 3.0% | 17.0% |
| 16 | 4.0% | 21.0% |
| 17 | 4.0% | 25.0% |
| 18 | 5.0% | 30.0% |
| 19 | 5.0% | 35.0% |
| 20 | 6.0% | 41.0% |
| 21 | 6.0% | 47.0% |
| 22 | 9.0% | 56.0% |
| 23 | 10.0% | 66.0% |
| 24 | 11.0% | 77.0% |
| 25 | 11.0% | 88.0% |
| 26 | 3.0% | 91.0% |
| 27 | 3.0% | 94.0% |
| 28 | 2.0% | 96.0% |
| 29 | 2.0% | 98.0% |
| 30 | 1.0% | 99.0% |
| 31 | 1.0% | 100.0% |
| 32 | | 100.0% |
| 33 | | 100.0% |
| 34 | | 100.5% |
| 35 | | 101.0% |
| 36 | | 101.5% |
| 37 | | 102.0% |
| 38 | | 103.0% |
| 39 | | 104.0% |
| 40 | | 105.0% |

As one can see, using the present example the total replacement percentage of the ties after forty years is only 105% versus 284% for wooden ties.

Using a sales price for wood of eighty dollars, and including an indirect cost associated with the wood ties of twenty five dollars for labor and equipment, maintenance for installing and replacing the wood ties, etc., and assuming a three percent inflation rate for the costs, one can track the costs of using the wood ties for the forty year period.

wood

| | Direct Plus | | |
|---|---|---|---|
| | Indirect | Cumulative | Direct |
| year | costs | costs | costs |
| 1 | 105.0 | 105.0 | 80.0 |
| 2 | 0.5 | 105.5 | 0.4 |
| 3 | 0.6 | 106.1 | 0.4 |
| 4 | 1.1 | 107.2 | 0.9 |
| 5 | 5.9 | 113.2 | 4.5 |
| 6 | 6.1 | 119.2 | 4.6 |
| 7 | 12.5 | 131.8 | 9.6 |
| 8 | 25.8 | 157.6 | 19.7 |
| 9 | 33.3 | 190.9 | 25.3 |
| 10 | 23.3 | 214.1 | 17.7 |
| 11 | 7.1 | 221.2 | 5.4 |
| 12 | 5.8 | 227.0 | 4.4 |
| 13 | 4.5 | 231.5 | 3.4 |
| 14 | 3.1 | 234.6 | 2.3 |
| 15 | 3.2 | 237.8 | 2.4 |
| 16 | 0.0 | 237.8 | 0.0 |
| 17 | 0.8 | 238.6 | 0.6 |
| 18 | 0.9 | 239.5 | 0.7 |
| 19 | 1.8 | 241.3 | 1.4 |
| 20 | 9.2 | 250.5 | 7.0 |
| 21 | 9.5 | 260.0 | 7.2 |
| 22 | 19.5 | 279.5 | 14.9 |
| 23 | 40.2 | 319.7 | 30.7 |
| 24 | 51.8 | 371.5 | 39.5 |
| 25 | 36.3 | 407.8 | 27.6 |
| 26 | 11.0 | 418.8 | 8.4 |
| 27 | 9.1 | 427.9 | 6.9 |
| 28 | 7.0 | 434.9 | 5.3 |
| 29 | 4.8 | 439.7 | 3.7 |
| 30 | 4.9 | 444.6 | 3.8 |
| 31 | 0.0 | 444.6 | 0.0 |
| 32 | 1.3 | 445.9 | 1.0 |
| 33 | 1.4 | 447.3 | 1.0 |
| 34 | 2.8 | 450.1 | 2.1 |
| 35 | 14.3 | 464.4 | 10.9 |
| 36 | 14.8 | 479.2 | 11.3 |
| 37 | 30.4 | 509.6 | 23.2 |
| 38 | 62.7 | 572.3 | 47.8 |
| 39 | 80.7 | 653.0 | 61.5 |
| 40 | 56.5 | 709.5 | 43.1 |

In year one, the costs are the eighty dollars for the wood ties and the twenty five dollars in indirect costs, for a total of $105 dollars. In year two, using the probability table the failure rate of 0.5% of the wooden ties, after accounting for one year's inflation, results in an additional cost of $0.50 and a total cost of $105.50. Using the same procedure, the table is generated resulting in a total cost of $250.50 after twenty years and $709.50 after forty years, accounting for inflation. A similar table is generated for composite ties:

composite

| | Direct Plus | | |
|---|---|---|---|
| | Indirect | Cumulative | Direct |
| year | Costs | Costs | Costs |
| 1 | 125.0 | 125.0 | 100.0 |
| 2 | 0.0 | 125.0 | 0.0 |
| 3 | 0.7 | 125.7 | 0.5 |
| 4 | 0.7 | 126.3 | 0.5 |
| 5 | 0.7 | 127.0 | 0.6 |
| 6 | 0.7 | 127.8 | 0.6 |
| 7 | 1.5 | 129.3 | 1.2 |
| 8 | 1.5 | 130.8 | 1.2 |
| 9 | 1.6 | 132.4 | 1.3 |
| 10 | 1.6 | 134.0 | 1.3 |
| 11 | 1.7 | 135.7 | 1.3 |
| 12 | 3.5 | 139.2 | 2.8 |
| 13 | 3.6 | 142.7 | 2.9 |
| 14 | 5.5 | 148.2 | 4.4 |
| 15 | 5.7 | 153.9 | 4.5 |
| 16 | 7.8 | 161.7 | 6.2 |
| 17 | 8.0 | 169.7 | 6.4 |
| 18 | 10.3 | 180.0 | 8.3 |
| 19 | 10.6 | 190.7 | 8.5 |
| 20 | 13.2 | 203.8 | 10.5 |
| 21 | 13.5 | 217.4 | 10.8 |
| 22 | 20.9 | 238.3 | 16.7 |
| 23 | 24.0 | 262.3 | 19.2 |
| 24 | 27.1 | 289.4 | 21.7 |
| 25 | 28.0 | 317.4 | 22.4 |
| 26 | 7.9 | 325.2 | 6.3 |
| 27 | 8.1 | 333.3 | 6.5 |
| 28 | 5.6 | 338.8 | 4.4 |
| 29 | 5.7 | 344.6 | 4.6 |
| 30 | 2.9 | 347.5 | 2.4 |
| 31 | 3.0 | 350.5 | 2.4 |
| 32 | 0.0 | 350.5 | 0.0 |
| 33 | 0.0 | 350.5 | 0.0 |
| 34 | 1.7 | 352.2 | 1.3 |
| 35 | 1.7 | 353.9 | 1.4 |
| 36 | 1.8 | 355.7 | 1.4 |
| 37 | 1.8 | 357.5 | 1.4 |
| 38 | 3.7 | 361.2 | 3.0 |
| 39 | 3.8 | 365.1 | 3.1 |
| 40 | 4.0 | 369.0 | 3.2 |

In year one, the costs are the one hundred dollars for the composite ties and twenty five dollars in indirect costs (the indirect costs are assumed constant for both wood and composite), for a total of $125 dollars. In year two, using the probability table the failure rate of 0.0% for the composite ties, there is no additional costs in year two. In year three, after accounting for two year's inflation and a 0.5% probability of replacement, the total cost is $125.7. Using the methodology outlined above, the total cost of using the composite ties is $203.80 after twenty years and $369.00 after forty years, accounting for inflation. If the values of the costs for both the wooden and composite ties are converted to a present value (assuming a discount rate of eight percent), the costs are as follows:

| | Net Present Value | | |
|---|---|---|---|
| | of total costs over: | | |
| client uses | 10 years | 20 years | 40 years |
| wood | $155.52 | $167.39 | $211.69 |
| composite | $96.76 | $140.34 | $164.25 |

The present value of the costs of the wood ties is appreciably higher in this example, illustrating the benefits of financing composite ties over its wood counterparts. From the standpoint of the supplier, the leasing arrangement provides an opportunity for income that surpasses the value of the proceeds from a sale. For example, assuming a cost to manufacture the ties at $70 and a lease of $15 per year, and using the probability chart for the anticipated failure/replacement characteristics of the composite ties, the chart below illustrates the cash flow comparison of the tie provider:

| | | | | | | Net |
|---|---|---|---|---|---|---|
| | Costs of | | | Cumulative | | Cash |
| | Providing | | | Cash Flow | | Flow |
| | Ties For | Proceeds | Net | Before | | Including |
| | Duration | from | Cash | Interest | Interest | Interest |
| year | Of Lease | Lease | Flow | Payment | Costs | Costs |
| 1 | 70 | 15 | −55.0 | −55.0 | 0.0 | −55.0 |
| 2 | 0.0 | 15 | 15.0 | −44.1 | −4.1 | 10.9 |
| 3 | 0.4 | 15 | 14.6 | −32.8 | −3.3 | 11.3 |
| 4 | 0.4 | 15 | 14.6 | −20.6 | −2.5 | 12.2 |
| 5 | 0.4 | 15 | 14.6 | −7.5 | −1.5 | 13.1 |
| 6 | 0.4 | 15 | 14.6 | 6.6 | −0.6 | 14.1 |
| 7 | 0.7 | 15 | 14.3 | 20.8 | 0.0 | 14.3 |
| 8 | 0.7 | 15 | 14.3 | 35.1 | 0.0 | 14.3 |
| 9 | 0.7 | 15 | 14.3 | 49.4 | 0.0 | 14.3 |
| 10 | 0.7 | 15 | 14.3 | 63.7 | 0.0 | 14.3 |
| 11 | 0.7 | 15 | 14.3 | 77.9 | 0.0 | 14.3 |
| 12 | 1.4 | 15 | 13.6 | 91.5 | 0.0 | 13.6 |
| 13 | 1.4 | 15 | 13.6 | 105.1 | 0.0 | 13.6 |
| 14 | 2.2 | 15 | 12.8 | 117.9 | 0.0 | 12.8 |
| 15 | 2.2 | 15 | 12.8 | 130.7 | 0.0 | 12.8 |
| 16 | 2.9 | 15 | 12.1 | 142.9 | 0.0 | 12.1 |
| 17 | 2.9 | 15 | 12.1 | 155.0 | 0.0 | 12.1 |
| 18 | 3.6 | 15 | 11.4 | 166.4 | 0.0 | 11.4 |
| 19 | 3.6 | 15 | 11.4 | 177.8 | 0.0 | 11.4 |
| 20 | 4.3 | 15 | 10.7 | 188.4 | 0.0 | 10.7 |
| 21 | 4.3 | 15 | 10.7 | 199.1 | 0.0 | 10.7 |
| 22 | 6.5 | 15 | 8.5 | 207.6 | 0.0 | 8.5 |
| 23 | 7.2 | 15 | 7.8 | 215.4 | 0.0 | 7.8 |
| 24 | 7.9 | 15 | 7.1 | 222.5 | 0.0 | 7.1 |
| 25 | 7.9 | 15 | 7.1 | 229.5 | 0.0 | 7.1 |
| 26 | 2.2 | 15 | 12.8 | 242.4 | 0.0 | 12.8 |
| 27 | 2.2 | 15 | 12.8 | 255.2 | 0.0 | 12.8 |
| 28 | 1.4 | 15 | 13.6 | 268.8 | 0.0 | 13.6 |
| 29 | 1.4 | 15 | 13.6 | 282.3 | 0.0 | 13.6 |
| 30 | 0.7 | 15 | 14.3 | 296.6 | 0.0 | 14.3 |
| 31 | 0.7 | 15 | 14.3 | 310.9 | 0.0 | 14.3 |
| 32 | 0.0 | 15 | 15.0 | 325.9 | 0.0 | 15.0 |
| 33 | 0.0 | 15 | 15.0 | 340.9 | 0.0 | 15.0 |
| 34 | 0.4 | 15 | 14.6 | 355.5 | 0.0 | 14.6 |
| 35 | 0.4 | 15 | 14.6 | 370.2 | 0.0 | 14.6 |
| 36 | 0.4 | 15 | 14.6 | 384.8 | 0.0 | 14.6 |
| 37 | 0.4 | 15 | 14.6 | 399.5 | 0.0 | 14.6 |
| 38 | 0.7 | 15 | 14.3 | 413.7 | 0.0 | 14.3 |
| 39 | 0.7 | 15 | 14.3 | 428.0 | 0.0 | 14.3 |
| 40 | 0.7 | 15 | 14.3 | 442.3 | 0.0 | 14.3 |

The first column in the table above is the number of years, and the second column is the costs associated with providing the composite ties. In year one, all the ties are assumed to be replaced or installed at a cost of $70 to the supplier. Each successive year follows the probability that a tie will need to be replaced, and the associated cost of replaced accounting for inflation at three percent. The next column is the proceeds from the lease, which here is assumed for purposes of this example is $15. The next column is the cash flow, which is the lease payment less the costs of replacing a tie. This is the income generated each year from the lease. The next column is the interest payment, which occurs in this example only in years two through six because those are the only years where the cash flow is negative. The last column is the cash flow for the supplier of the ties taking into consideration the interest on a deficit due to negative cash flow.

Converting the income for the producer to a net present value, a table can be generated as follows:

| | Present | | | |
|---|---|---|---|---|
| | Value of | Present | | |
| | Costs To | Value Of | | |
| | Provide | Income | | Net Cash Flow |
| Lease | Composite | From Lease | Interest | Including |
| Term | Ties | Payments | Costs | Interest |
| 40 | $81.38 | $178.87 | −$9.38 | $88.11 |
| 20 | $74.46 | $147.27 | −$9.38 | $63.43 |
| 10 | $67.34 | $100.65 | −$9.38 | $23.93 |

As one can see, the benefits of leasing the ties increase as the length of the lease enlarges. If the supplier sold the ties, with a sales price of $100 and a cost of $70 and indirect costs of $25, the advantages of the present system are very clear from the foregoing example.

The foregoing example illustrates the benefits of the lease agreement from the standpoint of the ties supplier. The advantages to the railway owner are clear, including freeing up start-up capital to spend elsewhere. When the corporate tax implications are included, the benefits to the railway operator are even greater.

The lease terms are closely related to projections for the rate of inflation, the discount rate of future costs/earnings as a net present value, and the estimated replacement schedule for the composite ties. These terms have a substantial role in the bottom line for the producer, assuming they have been carefully considered and incorporated into the price of the lease.

The following terms are commonly found in an equipment lease and provide additional information with respect to the scope of the present invention:

Certificate of Acceptance (Delivery and Acceptance)

A document whereby the lessee acknowledges that the equipment to be leased has been delivered, accepted, and has been manufactured or constructed according to specifications.

Discount Rate

An interest rate used to calculate the Present Value of future cash flows.

Economic Life (Useful Life)

The period of time during which an asset will have economic value and provide utility.

Effective Lease Rate

The effective rate (to the lessee) of cash flows resulting from a lease transaction. To compare this rate with a loan interest rate, a company must include in the cash flows any effect the transactions have on federal tax liabilities.

End-of-Term Options

Common end-of-term options for leased equipment include renewing the lease, purchasing the equipment, returning the equipment to the leassor, or a combination of renew/return.

Equipment Schedule

A document that describes in detail the equipment being leased. It may also state the lease term, commencement date, repayment schedule and location of the equipment.

Fair Market Purchase Option

An option to purchase leased property at the end of the lease term at its then fair market value. The leassor does not have the ability to retain title to the equipment if the lessee chooses to exercise the purchase option.

GAAP

Generally Accepted Accounting Principles.

Lease Rate (Rental Payment)

The periodic rental payment to a leassor for the use of assets. Others may define lease rate as the implicit interest rate in minimum lease payments.

Lessee

The user of the equipment being leased.

Leassor

The party to a lease agreement who has legal or tax title to the equipment, grants the lessee the right to use the equipment for the lease term, and is entitled to the rentals.

Master Lease

A contract where the lessee leases currently needed assets and is able to acquire other assets under the same basic terms and conditions without negotiating a new contract.

Modified Accelerated Cost Recovery System (MACRS)

The Tax Reform Act of 1986 established the MACRS tax appreciation system prescribing depreciation methods for each class in lieu of statutory tables. Equipment is assigned among 3, 5, 7, 10, 15, or 20 year classes depending on ADR lives.

Net Present Value

A project's net contribution to wealth-present value of cash flows minus initial investment.

Off Balance Sheet Financing

Any form of financing, such as an operating lease, which, for financial reporting purposes, is not required to be reported on a firm's balance sheet. Another name for an “operating lease” because the liability for long term (over 12 months) rent does not appear on the balance sheet.

Operating Lease

Any lease that is not a capital lease. These are generally used for short term leases of equipment. The lessee can acquire the use of equipment for just a fraction of the useful life of the asset. Additional services such as maintenance and insurance may be provided by the leassor.

Present Value

The current equivalent of payments or a stream of payments to be received at various times in the future. The present value will vary with the discount interest factor applied to future payments.

Purchase Option

A provision by which a lessee has the right to purchase the equipment at the end of the lease. The purchase option may be stated at a specified amount or at fair market value.

Residual Value

The value, either actual or expected, of leased equipment at the end, or termination, of the lease.

Return on Investment (ROI)

Generally, book income as a proportion of the book value of equity.

True Lease

A type of transaction that qualifies as a lease under the Internal Revenue Service Code. It allows the leassor to claim ownership and the lessee to claim rental payments as tax deductions.

Yield

Rate of return for the leassor in a lease investment.

It is also important to consider the issues that arise in such lease agreements. A brief discussion of the most common issues is presented below.

Term and rent. What is the initial term of the lease, and what is the rent? How and when must rent be paid? Rent can by paid monthly, quarterly, or other period mutually agreed upon by the parties to the agreement.

Claims against supplier. Does the lessee have the right to proceed directly against a supplier on warranties, refunds, price adjustments and other claims? Does the lessee have the right to retain any settlement? The lease will typically provide for claims by the lessee based on warranties, both expressed, implied, and inferred under the laws of the jurisdiction, as well as remedies and opportunities for self-help in the form of withholding of rent payments and other possibilities.

Transfers. Does the lease restrict the leassor's right to transfer an interest in the leased equipment? If the railroad operation is sold during the term of the lease, the lease agreement should provide for transfer of the equipment and the conditions and terms under which such transfer may occur.

Representations and indemnities. Are any special representations required to satisfy regulatory requirements? Is the lessee required to assume property taxes, license fees, public liability? To what extent is the lessee obligated to indemnify other parties against various other risks and expenses? The relative liabilities of the parties will be spelled out in the lease agreement, as well as the responsibilities of the parties concerning taxes, licenses, fees and public costs if any.

Claims. Can the lessee sue and take other action in the name of the leassor to assert claims against third parties? Is the lessee's right to settlements that compensate for losses protected?

Renewal options. Does the lease provide for renewal? If so, for what term and at what rent? It is important to keep in mind that renewal options may affect the tax treatment of the transaction.

Subleasing. May the lessee sublease the equipment? Under what conditions?

Maintenance. Who is obligated to maintain the equipment? The lessee should not accept a requirement that he provide a higher degree of maintenance than would be the case if he owned the equipment. Here, the railroad ties will in most cases be maintained by the supplier/leassor.

Improvements and modifications. Does the lessee have the right to make improvements or modifications to the equipment so that it better suits individual needs? Who is responsible for modifications required by regulatory agencies such as the EPA or OSHA?

Stipulated losses. What are the specified amounts that the lessee would owe in the event the equipment was lost, stolen, or destroyed by casualty? Are these charges in lieu of or in addition to the value of the lost equipment? Often, stipulated losses are based upon a formula incorporating rental payments for the balance of the lease term and the value of the lost tax advantages to the leassor. If the leassor has the right to sell the lease to investors seeking tax-sheltering advantages, the stipulated losses, sometimes stated in terms of making the leassor whole, may be figured with respect to their lost tax advantages rather than those of the original leassor.

Insurance. Who is responsible for insuring the equipment? Who is entitled to what part of any insurance settlement if the equipment is lost, stolen or damaged?

Amendments. Does the lease provide for amendments in case of changed circumstances or conditions? This is especially important in long-term leases, when the value of the equipment to the lessee may suddenly decline.

Purchase option. Does the lessee have the right to purchase the leased equipment? What is the option price and how and when may it be exercised? Keep in mind that purchase options may affect the tax treatment of the transaction.

Termination. Under what circumstances may the lease be prematurely terminated? Does destruction or loss of equipment terminate the agreement? Are any payments required because of premature termination? Does the lease provide for termination under certain circumstances or conditions, such as legal restrictions that make continued use of the equipment illegal or uneconomical?

Termination costs. Who is responsible for costs associated with returning equipment to the leassor at the end of the lease term? Dismantling, packing, shipping, insurance and related costs can be substantial.

Master leases. Does the lease require individual contract negotiations if the lessee wants to add another piece of equipment, or may the lessee make a simple addition to the regular contract describing the new equipment, the rate and the period of the new lease? The latter can yield substantial savings where an ongoing relationship is contemplated.

The foregoing is but a list of examples of factors that may be considered when putting together a lease agreement of the present invention. Applicant contends that none of the foregoing should be considered limiting or required by the scope of the present invention, except those steps and limitations found in the appended claims below. Rather, one skilled in the art will appreciate many deviations and departures for the above-described embodiments that will fall within the scope of the present invention, and the Applicant intends that all such departures and deviations be included within the scope of the present invention.

We claim:

1. A method for financing composite ties used in a railway system comprising:
acquiring a plurality of composite railroad ties made from a synthetic material;
identifying a customer for said composite ties;
entering into a lease agreement where possession of the railroad ties are transferred to the customer in exchange for future rent payments;
transferring possession of said composite ties to the customer that does not transfer ownership in the composite ties to the customer; and
collecting regularly scheduled payments from said customer pursuant to said written agreement.

2. The method for financing composite ties used in a railway system of claim 1 further comprising the step where ties are replaced by leassor under terms of said lease agreement.

3. The method for financing composite ties of claim 1 where the lease agreement is an operating lease.

4. The method for financing composite ties of claim 1 where the lease agreement includes a fair market purchase option at the end of the lease.

5. The method for financing composite ties of claim 1 where the lease agreement is part of a master lease agreement.

6. The method for financing composite ties of claim 1 where the lease agreement constitutes a true lease.

7. The method for financing composite ties of claim 1 where the lease agreement provides for a transfer of rights under the terms of the lease agreement.

8. The method for financing composite ties of claim 1 where the lease agreement provides for automatic renewal of the lease.

9. The method for financing composite ties of claim 1 where the lease agreement provided for conditions, if any, that subleasing can be arranged under the lease agreement.

10. The method for financing composite ties of claim 1 where the lease agreement provided for maintenance of the railroad ties.

11. The method for financing composite ties used in a railway system of claim 1 further comprising establishing a payment value based on a year-by-year replacement probability for the composite ties.

12. The method for financing composite ties used in a railway system of claim 1 further comprising establishing a payment value based on an estimated discount rate for the present value of a future cost/income.

13. The method for financing composite ties used in a railway system of claim 1, where the synthetic material is derived from recycled automobile tires.
